(19) United States
(12) Patent Application Publication
(10) Pub. No.: US 2007/0002984 A1
(43) Pub. Date: Jan. 4, 2007

(54) Signal processing device

(75) Inventor: Cho Jeong Hoon, Gyeonggi-do (KR)

Correspondence Address: BIRCH STEWART KOLASCH & BIRCH, PO BOX 747, FALLS CHURCH, VA, 22040-0747, US

(73) Assignee: LG INNOTEK CO., LTD

(21) Appl. No.: 11/453,102

(22) Filed: Jun. 15, 2006

(30) Foreign Application Priority Data
Jun. 17, 2005 (KR) 10-2005-0052215

(51) Int. Cl. H04B 1/10

(52) U.S. Cl. 375/350

(57) ABSTRACT

A signal processing device is provided. A signal processing device includes: a diplexer unit separating a first signal from signals that are received from an antenna to transmit the first signal to a first signal processing unit; a band pass filter unit transmitting a second signal in received signals from the diplexer unit to a second signal processing unit; and an LC tank unit cutting-off the transmitted second signal, and transmitting a third signal in the received signals from the diplexer unit to a third signal processing unit.

### BACKGROUND OF THE INVENTION

1. Field of the Invention

The present invention relates to a signal processing device.

2. Description of the Related Art

A related art dual band terminal includes a diplexer capable of receiving two respectively different frequencies (1900 MHz band (PCS) and 800 MHz (DCN))) through one antenna. However, the latest dual band terminal further includes a global position system (GPS) function, and thus uses a triple band terminal. The triple band terminal processes three frequency bands (PCS: 1850 to 1990 MHz, GPS: 1574.42 to 1576.42 MHz, and DCN: 824 to 894 MHz).

That is, current mobile communication terminals basically are equipped with a GPS function. For example, the FCC's E911 rules require a location tracking function (radio location determination) through a GPS satellite to provide precise location information of the mobile communication terminal.

FIG. 1 is a block diagram of components in a related art triple band mobile communication terminal 10.

Referring to FIG. 1, the related art triple band mobile communication terminal 10 includes an active switch 11, a DCN signal processing unit 12, a PCS signal processing unit 13, a GPS signal processing unit 14, and controller 15.

The active switch 11 performing a triplexer function receives respective signals of a DCN band, a PCS band, and a GPS bans through an antenna, and transmits signals of the DCN band and the PCS band.

The DCN signal processing unit 12 processes the signal of the DCN band separated from the active switch 11.

Moreover, the PCS signal processing unit 13 processes the signal of the DCN as a call signal, and the GPS signal processing unit 14 demodulates the signal of the GPS band to generate three-dimensional ground location determination information.

The controller 15 outputs the transmitted signal from the DCN signal processing unit 12 or the PCS signal processing unit 13 as a voice, transmits the received signal to the DCN processing unit 12 or the PCS signal processing unit 13, or processes the inputted ground location determination information from the GPS signal processing unit 14.

At this point, the antenna includes a dual band antenna and a GPS antenna. The dual band antenna transmits and receives signals in synchronization with the DCN/PCS signals. It is possible to realize the triple band using only one antenna through a triplexer that is not a single pole three throw (SP3T).

A related art triplexer can be realized as one chip using more than 10 lumped elements. However, problems can occur as follows.

First, as the number of receiving modes increase, a frequency interval between the receiving modes becomes closer. Thus, it is difficult to manufacture a filter for simultaneously filtering various signals. Especially, when a frequency interval in the GPS mode and the PCS mode becomes 280 MHz, it is very hard to manufacture a triplexer to separate signals, and also many lumped elements are necessary.

Second, since many lumped elements are necessary, it is difficult to minimize the product.

Third, when the triplexer is realized using the many lumped elements, the insertion loss occurs due to a high frequency, and also the ripples in a pass band increase according to the increase of the frequency band.

Accordingly, it is necessary to improve a structure of the related art triplexer to realize a high quality call service and miniaturization.

### SUMMARY OF THE INVENTION

Accordingly, the present invention is directed to a signal processing device that substantially obviates one or more problems due to limitations and disadvantages of the related art.

An object of the present invention is to provide a signal processing device minimizing the number of lumped elements.

Another object of the present invention is to provide a signal processing device maintaining stably each frequency band signal without a cross-talk effect by preventing a leakage current between adjacent circuits.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a signal processing device including: a diplexer unit separating a first signal from signals that are received from an antenna to transmit the first signal to a first signal processing unit; a band pass filter unit transmitting a second signal in received signals from the diplexer unit to a second signal processing unit; and an LC tank unit cutting-off the transmitted second signal, and transmitting a third signal in the received signals from the diplexer unit to a third signal processing unit.

In another aspect of the present invention, there is provided a signal processing device including: a diplexer unit separating a first signal, a second signal, and a third signal in received signals from an antenna; a first signal processing unit processing the first signal separated from the diplexer unit; a band pass filter unit passing the second signal and cutting-off the third signal in the second and third signals separated from the diplexer unit; a second signal processing unit connected to the band pass filter unit to process the second signal; an LC tank unit passing the third signal and cutting-off the second signal in the second and third signals separated from the diplexer unit; and a third signal processing unit connected to the LC tank unit to process the third signal.

In a further another aspect of the present invention, there is provided a signal processing device including: a diplexer unit including two types of band stop filters connected in parallel, one type passing a first signal and cutting-off a second signal and a third signal in received signals from an antenna, the other type passing a second signal and a third signal and cutting-off a first signal in the received signals from the antenna; a first signal processing unit processing the first signal separated from the diplexer unit; a bans pass filter passing the second signal and cutting-off the third signal in the second and third signals separated from the diplexer unit; a second signal processing unit connected to the band pass filter unit to process the second signal; an LC tank unit passing the third signal and cutting-off the second signal in the second and third signals separated from the diplexer unit; and a third signal processing unit connected to the LC tank unit to process the third signal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of components in a related art triple band mobile communication terminal;

FIG. 2 is a circuit diagram of components in a signal processing device according to an embodiment of the present invention;

FIG. 3 is a smith chart of an input impedance characteristic in a band pass filter according to an embodiment of the present invention;

FIG. 4 is a view of a circuit configuration in an LC tank according to an embodiment of the present invention;

FIG. 5 is a view of another diplexer in a signal processing device according to an embodiment of the present invention; and

FIG. 6 is view of signal transfer characteristics in a signal processing device according to an embodiment of the present invention.

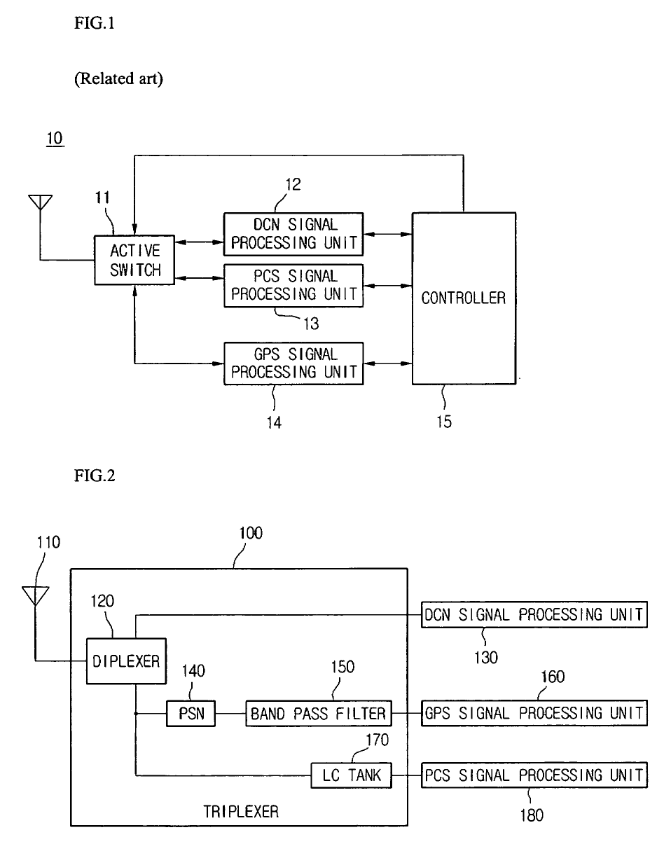

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

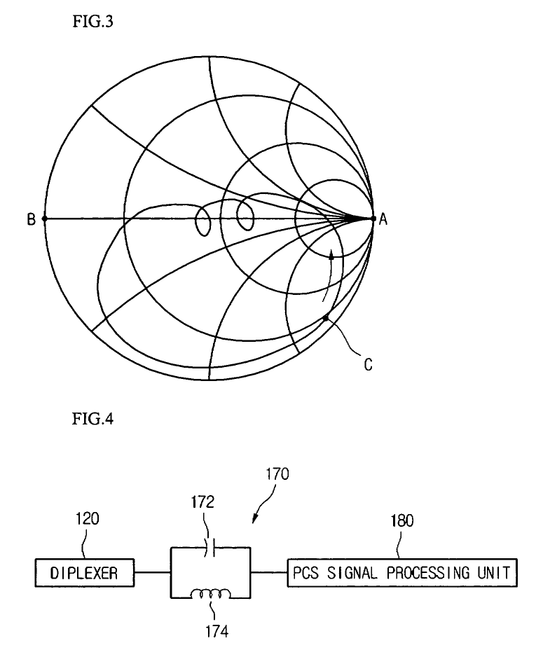

FIG. 2 is a circuit diagram of components in a signal processing device according to an embodiment of the present invention.

Referring to FIG. 2, a triplexer 100 includes a diplexer 120, a PSN (phase shift network), a band pass filter 150, and an LC tank 170.

An input terminal of the diplexer 120 is connected to an antenna 110. Additonally, output terminals of the diplexer 120, the band pass filter 150, and the LC tank 170 are, respectively, connected to a DCN signal processing unit 130, a GPS signal processing unit 160, and a PCS signal processing unit 180.

The triplexer 100 transmits and receives frequency signals (i.e., a DCN signal, a GPS signal, and a PCS signal) in a triple band through an antenna.

The diplexer 120 includes a high pass filter (HPF) and a low pass filter (LPF) with integrated passive devices, and applies a frequency division multiplex method to divide entire signals (mixed various frequency signals) into two frequency bands in which a frequency spectrum is not overlapped.

The HPF passes a GPS signal and a PCS signal of a high band in entire signals that are inputted from the antenna 110, and the LPF passes a DCN signal of a low band.

When the signals are divided, the diplexer 120 transmits the divided DCN signal into the DCN signal processing unit 130. Then, the DCN signal processing unit 130 processes the DCN signal and outputs a voice.

The PSN 140 and the LC tank 120 are connected in parallel to the diplexer 120. Additionally, the PSN 140 is connected in series to the band pass filter 150 and the GPS signal processing unit 160.

When the GPS signal and the PCS signal separated from the DCN signal flow into the PSN 140 and the LC tack 170, current becomes reduced, and also signal characteristics are distorted. Thus, the transmitting and receiving quality can be deteriorated.

That is, since the signals passing through the diplexer 100 to be separated from the DCN signal include the GPS signal and the PCS signal, a corresponding signal needs to be filtered to input, respectively, the GPS signal and the PCS signal into the GPS signal processing unit 160 and the PCS signal processing unit 180 without leakage.

For this, the PSN 140 allows impedance of the band pass filter 150 to operate as an open circuit in a PCS band.

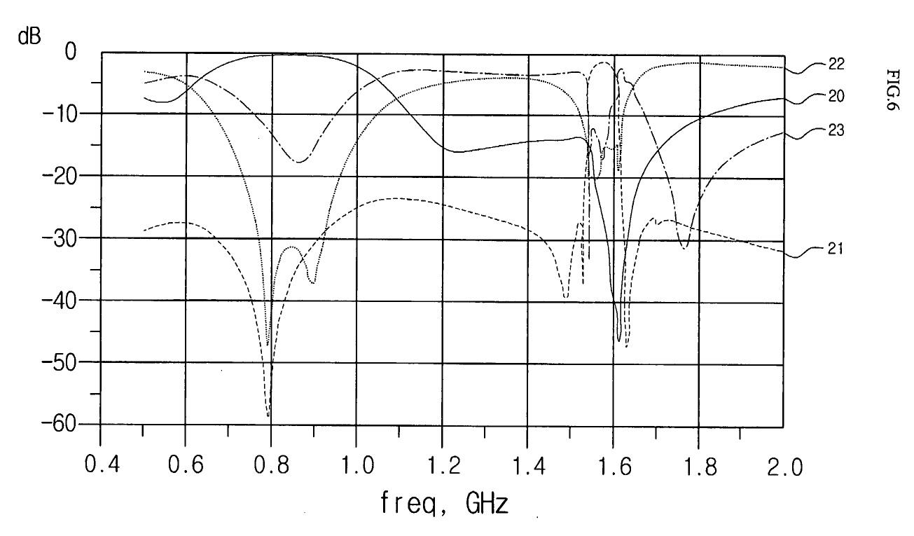

FIG. 5 is a view of another diplexer in a signal processing device according to an embodiment of the present invention.

A diplexer 220 includes a DCN band stop filter having an LC circuit to cut-off a DCN signal, and a PCS&GPS band stop filter having an LC circuit to cut-off the PCS and GPS signals. The DCN band stop filter and the PCS&GPS band stop filter are connected in parallel.

The diplexer 220 of FIG. 5 includes only four lumped elements, which are less than the number of lumped elements in diplexer 120 of FIG. 2 having the HPF and the LPF.

FIG. 3 is a smith chart of an input impedance characteristic in the band pass filter 150 according to an embodiment of the present invention.

Referring to FIG. 3, when load impedance coordinates of a signal are formed on point A in the smith chart, a circuit operates as an open circuit in an aspect of a signal. When load impedance coordinates of a signal are formed on point B in the smith chart, a circuit operates as a short circuit in an aspect of a signal.

In the PCS band, input impedance coordinates of the band pass filter 150 are formed on point C. Moreover, the load impedance coordinates C of the PCS signal is moved to an opening point A of the band pass filter 150 through the PSN 140.

Accordingly, since the band pass filter 150 operates as an open circuit in an aspect of a PCS signal, the PCS signal does not flow into the band pass filter 150, but flows into the LC tank 170 without a signal loss.

On the other hand, the GPS signal passing through the PSN 140 flows into the GPS signal processing unit 160 through the band pass filter 150. Then, the GPS signal processing unit 160 decodes the GPS signal to generate a position information.

The band pass filter 150 includes a GPS saw filter.

As described above, since the PSN 140 and the LC tank 170 are connected in parallel to the diplexer 120, the GPS signal and the PCS signal separated from DCN signal in the diplexer 120 flow into the PSN 140, the band pass filter 150, and the LC tank 170.

Thus, an impedance matching is performed in the PSN 140 to move impedance coordinates of the PCS signal into an opening point. Accordingly, the LC tank 170 operates as an open circuit in the GPS band to prevent the GPS signal from being leaked to the PCS signal processing unit 180.

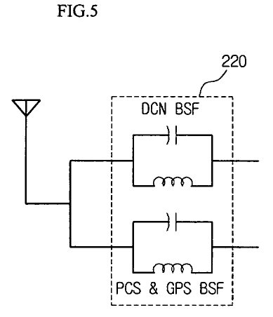

FIG. 4 is a view of a circuit configuration in the LC tank 170 according to an embodiment of the present invention.

Referring to FIG. 4, The LC tank 170 includes an inductor 174 and a capacitor 172, which are connected in parallel. The LC tank 170 cuts-off the GPS signal in the GPS signal and the PCS signal flowing from the diplexer 120.

Accordingly, the LC tank 170 operates as an open circuit in an aspect of the GPS signal, and most of the GPS signal flow into the band pass filter 150 without a current loss.

The PCS signal passing through the LC tank 170 is inputted into the PCS signal processing unit 180, and then the PCS signal processing unit 180 analyzes the signal to output a voice, or processes the signal as data.

FIG. 6 is view of signal transfer characteristics in a signal processing device according to an embodiment of the present invention.

A line of a reference numeral 20 represents transmitting characteristics of a signal transmitted from the antenna 110 into the DCN signal processing unit 130. A line of a reference numeral 21 represents signal transmitting characteristics of a signal transmitted from the antenna 110 into the GPS signal processing unit 160.

A line of a reference numeral 22 represents transmitting characteristics of a signal transmitted from the antenna 110 into the PCS signal processing unit 180. A line of a reference numeral 23 represents transmitting characteristics of a signal transmitted from the antenna 110 into the antenna 110.

According to the present invention, an insertion loss of an 849.1 MHz band signal that is transmitted from the antenna 110 into the DCN signal processing unit 130 is −0.257 dB. An insertion loss of a 1.576 GHz band signal that is transmitted from the antenna 110 into the GPS signal processing unit 160 is −1.073 dB. An insertion loss of a 1.85a GHz band signal that is transmitted from the antenna 110 into the PCS signal processing unit 180 is −1.423 dB.

According to the signal processing unit of the present invention, since a triplexer can be manufactured using the minimum number of lumped elements, miniaturization can be achieved. Additionally, since a leakage current between adjacent circuits is effectively cut off, a transmitting and receiving quality can be improved.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A signal processing device comprising:
a diplexer unit separating a first signal from signals that are received from an antenna to transmit the first signal to a first signal processing unit;
a band pass filter unit transmitting a second signal in received signals from the diplexer unit to a second signal processing unit; and
an LC tank unit cutting-off the transmitted second signal, and transmitting a third signal in the received signals from the diplexer unit to a third signal processing unit.

2. The signal processing device according to claim 1, further comprising a phase shifter unit connected between the diplexer unit and the band pass filter unit, and adjusting an opening point to prevent the third signal from being leaked to the band pass filter unit and the second signal processing unit.

3. The signal processing device according to claim 2, wherein the phase shifter unit includes a PSN (phase shift network).

4. The signal processing device according to claim 1, wherein the LC tank unit includes a parallel circuit of an inductor and a capacitor.

5. The signal processing device according to claim 1, wherein the band pass filter unit includes a saw filter.

6. The signal processing device according to claim 1, wherein the diplexer unit includes a high pass filter and a low pass filter, which have an IPD (integrated passive device).

7. A signal processing device comprising:
a diplexer unit separating a first signal, a second signal, and a third signal in received signals from an antenna;
a first signal processing unit processing the first signal separated from the diplexer unit;
a band pass filter unit passing the second signal and cutting-off the third signal in the second and third signals separated from the diplexer unit;
a second signal processing unit connected to the band pass filter unit to process the second signal;
an LC tank unit passing the third signal and cutting-off the second signal in the second and third signals separated from the diplexer unit; and
a third signal processing unit connected to the LC tank unit to process the third signal.

8. The signal processing unit according to claim 7, further comprising a phase shifter unit connected between the diplexer unit and the band pass filter unit, and adjusting an opening point to prevent the third signal from being leaked to the band pass filter unit and the second signal processing unit.

9. The signal processing unit according to claim 8, wherein the phase shifter unit includes a PSN.

10. The signal processing device according to claim 7, wherein the LC tank unit includes a parallel circuit of an inductor and a capacitor.

11. The signal processing device according to claim 7, wherein the band pass filter unit includes a saw filter.

12. The signal processing device according to claim 7, wherein the diplexer unit includes a high pass filter and a low pass filter, which have an IPD.

13. A signal processing device comprising:
a diplexer unit including two types of band stop filters connected in parallel, one type passing a first signal and cutting-off a second signal and a third signal in received signals from an antenna, the other type passing a second signal and a third signal and cutting-off a first signal in the received signals from the antenna;
a first signal processing unit processing the first signal separated from the diplexer unit;
a bans pass filter passing the second signal and cutting-off the third signal in the second and third signals separated from the diplexer unit;
a second signal processing unit connected to the band pass filter unit to process the second signal;
an LC tank unit passing the third signal and cutting-off the second signal in the second and third signals separated from the diplexer unit; and
a third signal processing unit connected to the LC tank unit to process the third signal.

14. The signal processing device according to claim 13, wherein the phase shifter unit is connected between the diplexer unit and the band pass filter unit.

15. The signal processing device according to claim 13, wherein the band pass filter unit includes a saw filter.

16. The signal processing device according to claim 13, wherein the first signal processing unit is a DCN signal processing unit.

17. The signal processing device according to claim 13, wherein the second signal processing unit is a GPS signal processing unit.

18. The signal processing device according to claim 13, wherein the third signal processing unit is a PCS signal processing unit.
